(19) United States
(12) Patent Application Publication
(10) Pub. No.: US 2002/0078045 A1
(43) Pub. Date: Jun. 20, 2002

(54) System, method, and program for ranking search results using user category weighting

(76) Inventor: Rabindranath Dutta, Austin, TX (US)

Correspondence Address: Leslie A. Van Leeuwen, International Business Machines Corp., 11400 Burnet Rd. -4054, Austin, TX, 78758, US

(21) Appl. No.: 09/737,995

(22) Filed: Dec. 14, 2000

(51) Int. Cl. G06F 7/00

(52) U.S. Cl. 707/7

(57) ABSTRACT

In a system, method and program for ordering search results of files available over a network, search results obtained by a search engine server may be ranked by associating user category weights with each file indexed in a search database. Search results may be provided to a user ranked in accordance with one or more user categories. The search results may augment additional search results ranked in accordance with additional ranking criteria. A system for implementing the ranking of search results may include a search engine server. The search engine server may interface with a plurality of network clients and information content servers. The search engine server may include one or more storage devices containing program instructions and data to perform the methods described herein. The program instructions and data may be included on a carrier medium, which may be a transmission medium or a storage medium.

### RELATED APPLICATIONS

This application is related to the following pending U.S. patent applications: Ser. No. 09/464,850, filed Dec. 16, 1999, entitled “Method, System, and Program for Ordering Search Results Using Popularity Weighting,” Ser. No. 09/549,153, filed Apr. 13, 2000, entitled “Method, System, and Program for Ordering Search Results Using an Importance Weighting,” and Ser. No. 09/569,503, filed May 11, 2000, entitled “System, Method, and Program for Augmenting Information Retrieval in a Client/Server Network Using Client-Side Searching,” all by Rabindranath Dutta.

### BACKGROUND OF THE INVENTION

1. Field of the Invention

This invention relates to networks of computational devices, and more particularly to ranking search results of information accessible over a network, using user classification weighting.

2. Description of the Related Art

The following descriptions and examples are not admitted to be prior art by virtue of their inclusion within this section.

The Internet comprises a vast number of computers and computer networks that are globally interconnected through communication links. The connected computers communicate with each other via a set of protocols called TCP/IP (Transmission Control Protocol/Internet Protocol). An especially popular aspect of the Internet is the World Wide Web (“WWW” or “web”), which is a collection of interlinked documents, or files. These documents, or “web pages,” may incorporate text, graphics, audio, and/or video content, and may include links to one another, often called “hyperlinks.” The web allows a server computer system (e.g., web server or website) to send web pages, stored on a server-side storage medium, to a remote client computer system. The client computer system can then display the web pages via a web browser, a software application that typically resides on the client computer system.

The web may use a messaging protocol known as the HyperText Transfer Protocol (“HTTP”) for exchanging information contained in the web pages. HTTP defines how the information is formatted and transmitted, and what actions the web servers and web browsers should perform in response to the client inputs. Web pages may be defined using the HyperText Markup Language (“HTML”). HTML provides a standard set of tags that define how a web page is to be displayed. Each web page may be uniquely identifiable by a Uniform Resource Locator (“URL”), an Internet standard syntax for the global addresses of web pages. Thus, in an exemplary WWW communication process, a user (on a client computer system) accessing the web, through a web browser, specifies the URL for a specific web page through a HTTP request. The request is forwarded to the web server that supports the web page. Upon receiving the HTTP request, the web server sends the desired web page, in HTML format, to the client computer system. The web browser translates the HTML formatted web page and displays it on the client computer system for viewing by the user.

A valuable feature of the Internet is the absence of central organization. A web server hosting a plurality of web pages can be readily connected to the Internet with minimal capital investment. As a result, the variety and availability of information accessible through the web is tremendous and ever increasing. Although the decentralization allows convenient access to the information stored on the web pages, identifying and locating specific types of information becomes quite difficult. For this reason, various database systems, including web search engines and directories, have been developed to aid users in finding the desired information. These database systems typically contain an entry for each web page included in the database, such that the database can be searched relatively quickly without the need to retrieve the actual web pages in order to perform a search. An entry may include, for example, a URL along with one or more keywords associated with the page content and also a brief summary of the page content. Although the term “search engine” is commonly used to describe any such database system, a “search engine” can be distinguished from a “directory” in that a search engine collects the database entries automatically using programs often known as “spiders,” “robots,” or “crawlers.” These automated programs visit web pages and collect the needed data. Examples of presently available search engines include AltaVista and Excite. In contrast, a directory may describe a database for which entry information is manually submitted, typically by the website developer. Yahoo! is an example of a currently available Internet directory. Yahoo! also presently provides a search engine known as Inktomi. Generally speaking, the term “search engine” as used herein may refer to either of these database systems.

As mentioned above, search engines can index various information from visited web pages to associate with the located URL. Search engines may also index keywords included in a special keyword Meta tag in the HTML document that holds the keywords. The keywords are inserted into the document by the web page designer and intended to designate the content of the web page. Search engines may also include alternative text associated with images and perform word stemming to include variations of a keyword. For example, variations of the keyword “politics” such as “politician” and “political” may also be included in the index. The indexed keywords for a specific URL are then searched when a user enters a search request and URLs having the indexed keywords that match the search terms are returned as the search results.

Users frequently use a search engine to locate documents on the Internet. The user may enter one or more search terms along with Boolean operators for the search. The search query is transmitted to a search engine server that processes the search query and returns a plurality of web pages matching the user's request. However, due to the immense amount of information available over the Internet, a search query may frequently return an extraordinary number of web pages for a user to examine. In some cases, a considerable portion of these web pages may be not immediately relevant to the user's search query. In addition, the sheer amount of web pages matching the search results makes examining the more relevant web pages problematic to the user. Consequently, a search engine may employ some form of ordering of the search results to aid the user. One approach utilizes the location and frequency of keywords on a web page as the basis of ranking the search results. After obtaining the URLs matching the search keywords, the search engines may order the search results based on the number of search keywords included in the Meta tag and/or content of the web page. The search engine may also order the search results based on the number of web pages that include hyperlinks to the URL page of the search result. In both such cases, the search engine is fundamentally assigning an importance weighting to each returned search result to provide an ordered search result in accordance with the importance weighting. A search engine may also order the results according to popularity of the web pages. Such popularity ratings may be arrived in various ways. In one example, the search engine may monitor the frequency of the web pages selected by users on their presented search results. The amount of time spent on the specific web pages may also be monitored. The web pages that are selected by the users achieve higher ranking, while the web pages that are consistently ignored are assigned a lower ranking.

Unfortunately, ranking of search results by ranking algorithms such as importance or popularity weighting methods described above may not provide ordered results which are most appropriate to the user's needs. For instance, in the case of ranking by popularity weighting, in many instances users may view a web page inadvertently without having much interest in the content of that web page. Such accidental selections may artificially boost a web page's ranking and erroneously affect search results provided by the search engine. Moreover, if a portion of the users share similar demographics, selections of their search results may skew the popularity weighting even further. Search results may also be influenced by external factors such as advertising revenue to a search engine's web site.

It would therefore be desirable to develop a system and method to improve the usability of search results provided to a user by a search engine. Such a system and method would allow for improved information retrieval over a network to suit the user's request. The search results may further allow for quicker retrieval of the more pertinent information as desired by the user.

### SUMMARY OF THE INVENTION

The problems outlined above are in large part addressed by a system, method, and program for ranking search results for files available over a network. Users of a search service may be categorized into one or more of plurality of user categories. Search results provided by the search service may then be ranked in accordance with a user category. Furthermore, search results ranked in accordance with a user category may augment search results ranked in accordance with additional ranking criteria. Such methods may allow a user to examine results, which are more relevant, quickly and efficiently.

In an embodiment for a method of identifying files available over a network, a search query from a user, who may be associated with a user category, is received and search results are provided to the user, in which the search results are ranked in accordance with the user category. Additional search results may be provided to the user as well. The additional search results may include the search results ranked in accordance with an alternate user category that is dissimilar to the user category. The method may further include identifying the category of the user. Identifying the category of the user may be accomplished by various means. In one embodiment, the user may be identified by registering the user and assigning at least one of a plurality of user categories to the user based on the information provided in the process of registering. Alternatively, the user category may be identified by extracting one of the plurality of user categories from the user's e-mail address. The user category may also be identified by receiving a request from the user for a desired user category. User categories may be defined according to the needs of the network and may include topics such as, age level, profession, geographical location, hobbies and/or interests for example. The methods as described herein may be performed by a search engine server and may further be performed over a network such as the Internet.

The search query may include one or more search keywords. Providing search results to the user may include searching the entirety of a database. The database may include entries of indexed files available over the network. Each indexed file may be associated with a category weight. A search result list may be generated and include one or more files each corresponding to at least one of the search keywords. The list, ranked in accordance with the user category, may then be returned to the user. The list may be ranked such that the file having the highest category weight is ranked first while the file having the lowest category weight is ranked last. Category weights may be associated to the indexed files through various means. In an embodiment, a file may be associated with a category weight based on the user category tag of the file. The user category tag may be a Meta tag. Alternatively, the category weight may be associated based on the file address. The category weight may also be associated based on the file content. An additional weight factor may be associated with each indexed file. The additional weight factor may be a part of additional ranking criteria independent of the user category. The additional weight factor may be used in returning search results to the user in which the search results may be ranked in accordance with the combined user category and additional weights values. In an embodiment, the search result list may be ranked such that the file having the highest combined category and additional weight values may be ranked first and the file having the lowest combined category and additional weight values may be ranked last. Accordingly, the search results ranked in accordance with a user category may be augmented with search results ranked in accordance with the additional ranking criteria.

An embodiment of a system for identifying files available over a network includes a search engine server. The server may be adapted to receive a search query from a user associated with a user category and to provide search results to the user. Search results may be a list of files corresponding to the search query. The search results may be ranked in accordance with the user category. The search engine may further be adapted to provide additional search results to the user. The additional search results include the search results ranked in accordance with an alternate user category. The search engine server may further be adapted to identify the category of the user. The server may also be adapted to associate a category weight with each file indexed in a search database. The server may then be adapted to return search results such that a search result list is ranked starting with the file having the highest category weight and ending with the file having the lowest category weight. The server may further be adapted to associate an additional weight with each indexed file. The additional weight may be associated with additional ranking criteria independent of the user category. The server may then be further adapted to provide search results such that a search result list is ranked starting with the file having the highest combined user category and additional weight values and ending with the file having the lowest combined user category and additional weight values.

Another embodiment of a system for identifying files available over a network includes a search engine server. The search engine server may be adapted to interface with one or more network clients. The network clients may provide means for one or more users to connect to the search engine server. The server may include search instructions, stored in one or more storage devices, for receiving a search query from a user and for providing search results to the user. The search results may be ranked in accordance with a user category. The server may further include identification instructions for identifying a category of the user. The identification instructions may be stored in the storage device. The server may further include instructions on the storage device for associating a category weight with each file indexed in a search database. Instructions for associating an additional weight with each indexed file may be included with search engine server as well. The additional weight may be associated with additional ranking criteria independent of the user category. The search database may be stored in the storage device and include data associated with the user category weight, the additional weight, and for identifying the user category.

A computer-usable carrier medium is also contemplated. The carrier medium may include first program instructions executable on a computational device for receiving a search query for a user. The user may be associated with a user category. The carrier medium may also include second program instructions executable on a computational device for providing search results to the user. The search results may be ranked in accordance with the user category. The search results may also be ranked in accordance with an alternate user category dissimilar to said user category. The second program instructions may be further executable to search an entirety of a database. The database may include entries of indexed files available over a network. The second program instructions may also be executable to provide search results comprising a list of indexed files corresponding to the search query and to rank the list starting with the file having the highest category weight value and ending with the file having the lowest category weight value. The category weight may be associated with each file indexed in the database and be further executable on a computational device via fourth program instructions. Third program instructions executable on a computational device may also be included on the carrier medium. The third program instructions may be executable for identifying the category of the user. The third program instructions may further be executable to identify the category of the user by extracting one of the plurality of user categories for the use's e-mail address and assigning the user category to the user based on the extracting of the e-mail address. Alternatively, the third program instructions may further be executable to identify the category of the user by registering the user and assigning one of a plurally of user categories to the user based on the registering process.

Another embodiment of a computer-usable carrier medium is also contemplated. The carrier medium may include first program instructions executable on a computational device for associating a user category weight to each file indexed in a search database. The first program instructions may further be executable for associating an additional weight to each indexed file. The additional weight may include ranking criteria independent of the user category weight. The first program instructions may further be executable for associating the category weight by extracting the category weight from the file address. Alternatively, the first program instructions may further be executable for associating the category weight by extracting the category weight from the file content or from a user category tag of the file. In an embodiment, the user category tag may be the Meta tag. The carrier medium may further include second program instructions executable on a computational device for generating a search result list. The search results may be ranked starting with the file having the highest category weight value and ending with the file have the lowest category weight value. The second program instructions may be further executable for generating a search result list in which the search results are ranked starting with the file having the highest combined category and additional weight values and ending with the file having the lowest combined category and additional weight values.

### BRIEF DESCRIPTION OF THE DRAWINGS

Other objects and advantages of the invention will become apparent upon reading the following detailed description and upon reference to the accompanying drawings in which:

FIG. 1 is a block diagram illustrating an exemplary client/server network system including a search engine server;

FIG. 2 is a block diagram illustrating an embodiment of a system for identifying stored information accessible over a client/server network using the methods described herein;

FIG. 3 is a flow diagram illustrating an embodiment of a method for ranking search results of files available over a network;

FIG. 4 is a flow diagram illustrating an embodiment of a method for ranking search results of files available over a network;

FIG. 5 is a diagram illustrating an embodiment of a search result list;

FIG. 6 is table illustrating an embodiment of a portion of a database that may be used by the methods described herein;

FIG. 7 is a block diagram illustrating an exemplary search scenario using embodiments of the methods described herein; and

FIG. 8 illustrates exemplary search results obtained by the search scenario of FIG. 7 using embodiments of the methods described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

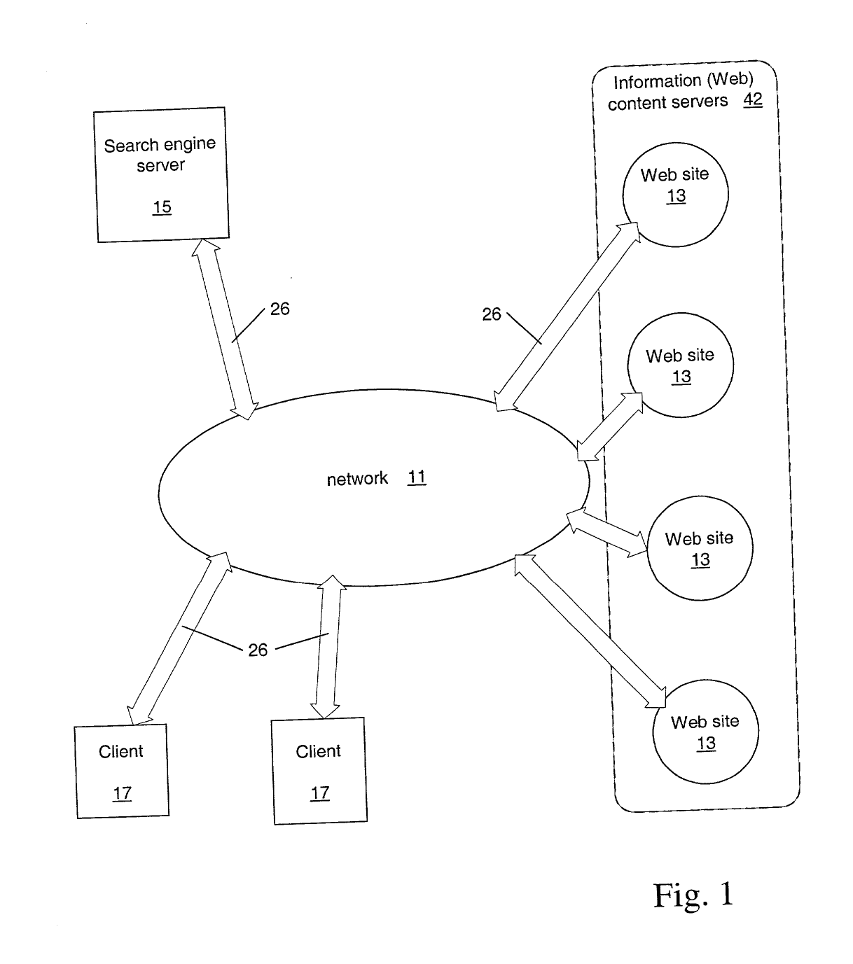

An illustration of a client-server network containing a search engine server is shown in FIG. 1. Network 11 connects various computational devices, such as search engine server 15, clients 17, and information content servers 42. Although these computational devices are shown outside of the oval representing network 11 for clarity, these devices are actually a part of the network as well. Network 11 may be the World Wide Web, and may include a plurality (e.g., millions) of web content servers 42, represented collectively by the surrounding dashed line. Each content server may store, or “host,” one or more web sites 13. Each web site may include one or more web pages. Transmission media 26 are used to connect the search engine server, clients, and content servers to network 11, which may include other transmission media and computational devices interconnected with each other. In an exemplary search sequence, communication is established over network 11 between a client 17 and search engine server 15. The communication may be achieved through a web browser program residing on the client. Search terms, or keywords, are entered by a user of client 17, and transmitted to search engine server 15. Search engine server 15 executes the search query by searching the information available on the network, including information content servers 42, for documents, or web pages, corresponding to the search terms. This may be performed by searching a database stored on the search engine server, where the database includes previously-formatted entries corresponding to web pages, assigned a unique URL address, accessible over network 11. The search results may then be transmitted back to the requesting client. The client may then, for example, access particular web pages returned by the results over network 11 as desired by the user.

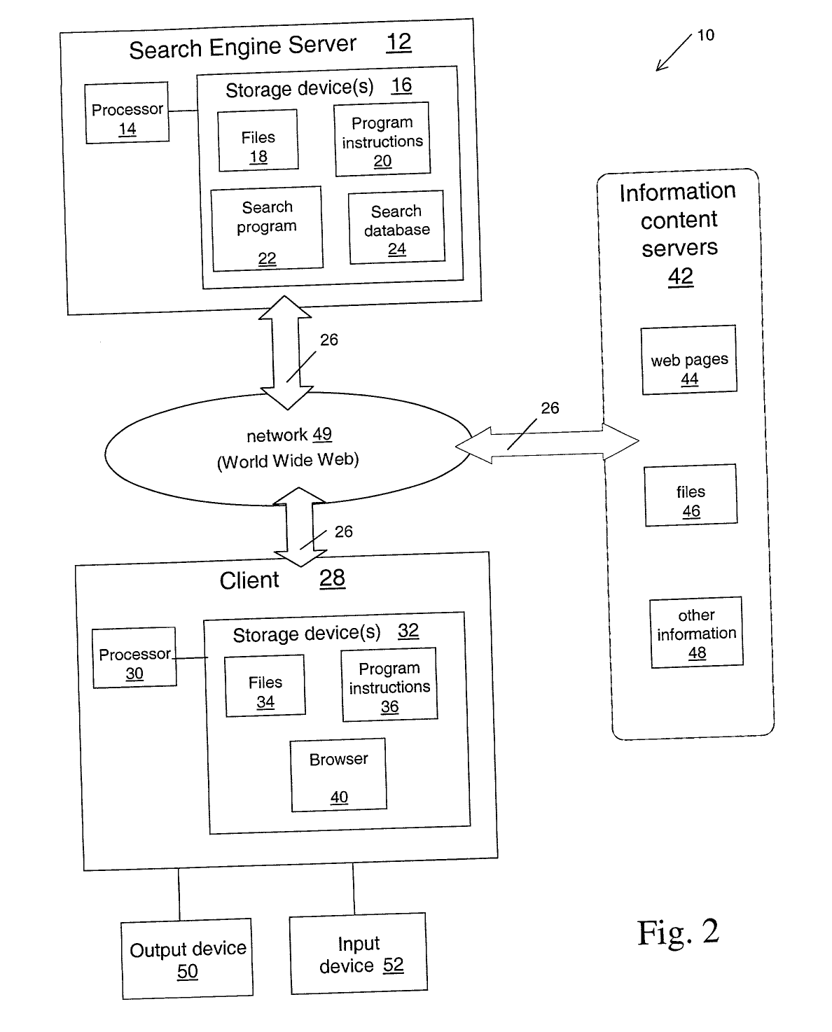

FIG. 2 illustrates an embodiment of a system 10 for identifying files accessible using a client/server network. System 10 may connect to a network similar to network 11 of FIG. 1, but with search engine server 12 and client 28 adapted for performing the methods described herein. Network 49 may be a TCP/IP network, such as the Internet and the WWW, or any other network system such as, Local-Area Network (LAN), Wide-Area Network (WAN), System-Area Network (SAN), Ethernet, or Token Ring, for example. Search engine server 12 is a computational device that may be, for example, a web server. Search engine server 12 may include processor 14 and one or more storage devices 16. Storage device, or storage medium, 16 may take on many forms, such as volatile or non-volatile memory, a magnetic disk such as a hard drive or a floppy drive, an optical disk, and/or a magnetic tape. Storage device 16 may include files 18 and program instructions 20. The program instructions may be stored as “executable files” in storage device 16 and loaded into system memory during execution. Program instructions 20 may include various program instructions used to implement networking functions of search engine server 12, such as program instructions used to implement the methods described herein. Files 18 may include documents such as web pages suitable for viewing by a user of the network, and may contain text, graphics, video and/or audio information. The files may exchange information in HTML or other suitable languages such as Extensible Markup Language (XML) or Wireless Markup Language (WML). Files 18 may also include other files suitable for use in communicating across network 11 or in identifying files accessible using network 11. For example, a file including a list of search results produced by search engine server 12 may be included in files 18. Broadly speaking, “files” as used herein may refer to any collection of data suitable for storing on a computational device or transferring within a network.

Storage device 16 may further include search program 22 and search database 24. Although search program 22 may be implemented using program instructions (or executables) such as instructions 20, search program 22 is shown separately in FIG. 2 to highlight this feature of the server. Search database 24 may be accessible by search program 22 for conducting search requests for information accessible over network 11. Search database 24 may be associated with a search engine as described above. The database may contain entries characteristic of files, documents, and/or other information stored on information content servers 42 (discussed further below) and accessible over network 11. Search program 22 may be adapted to receive from a client a search query from a user of the client. Alternatively, receiving of the search query could be implemented using other program instructions, such as instructions 20. Search program 22 may further include instructions for executing search queries and returning search results to the user corresponding to the search queries. Other instructions associated with the searching functions of search engine server 12 may reside in search program 22.

Transmission medium 26 may be used to connect search engine server 12 to other computational devices, such as client 28 and/or information content servers 42. Transmission medium may include, for example, a wire, cable, wireless transmission path, or a combination of these. Protocols used for communicating along transmission medium 26 may include, but are not limited to, TCP/IP, HTTP, Wireless Applications Protocol (WAP), File Transfer Protocol (FTP), and Gopher. System 10 may further include client computational device 28, linked to search engine server 12 using transmission medium 26.

Client 28 is a computational device and may include processor 30 and one or more storage devices 32. Storage device 32 is similar to storage device 16 described above, and may include files 34, program instructions 36, and a browser 40. Program instructions 36 may include various program instructions to allow client 28 to interface to search engine server 12. Files 34 may include various files stored on client 28, including files downloaded from information content servers 42. Files 34 may also include other files suitable for use in communicating across the network or in identifying files accessible using the network. Browser 40 may be, for example, a web browser that allows a user to retrieve and view files on the WWW, or a program that performs a similar function on another network type. Client 28 may also be associated with an output device 50 and input device 52. Output device 50 may include, for example, a display screen and/or a printer. Input device 52 may include, for example, a keyboard and/or pointing device such as a mouse or trackball.

Both search engine server 12 and client 28 may be linked to a plurality of information content servers 42 accessible using network 11. Though represented as one block in the diagram of FIG. 1, a network such as the Internet may contain millions of networked servers providing information content. Accordingly, network 11 may include a plurality of networked information content servers, search engine servers, and clients. Content servers 42 may include information content such as web pages 44, files 46, and/or other information 48. Although web pages such as web pages 44 are typically files, other files may be stored on network 11, such as files accessible using alternative protocols such as FTP. Other information 48 may include, for example, dynamically generated information such as responses to queries. Information content available using content servers 42 may be identifiable and addressed using a URL or suitably equivalent nomenclature. A nomenclature such as the URL may uniquely identify the location of the file associated with the file by assigning a unique file address to the file. Web pages 44, files 46, and other information 48 may be stored on one or more storage devices, not shown, of information content servers 42.

In FIG. 2 and any other block diagrams appearing herein, the blocks are intended to represent functionality rather than specific structure. Implementation of the represented system using circuitry and/or software could involve combination of multiple blocks into a single circuit, device, or program, or combination of multiple circuits, devices and/or programs to realize the function of a block. Furthermore, a system such as system 10 may include other elements not explicitly shown. For example, multiple search engine servers and/or clients not shown in FIG. 2 may be included in a system used for implementing the methods described herein. In another example, storage device 16 may be external to search engine server 12. Further, the search engine server, client, and/or information content servers may themselves include additional elements not shown for simplification purposes.

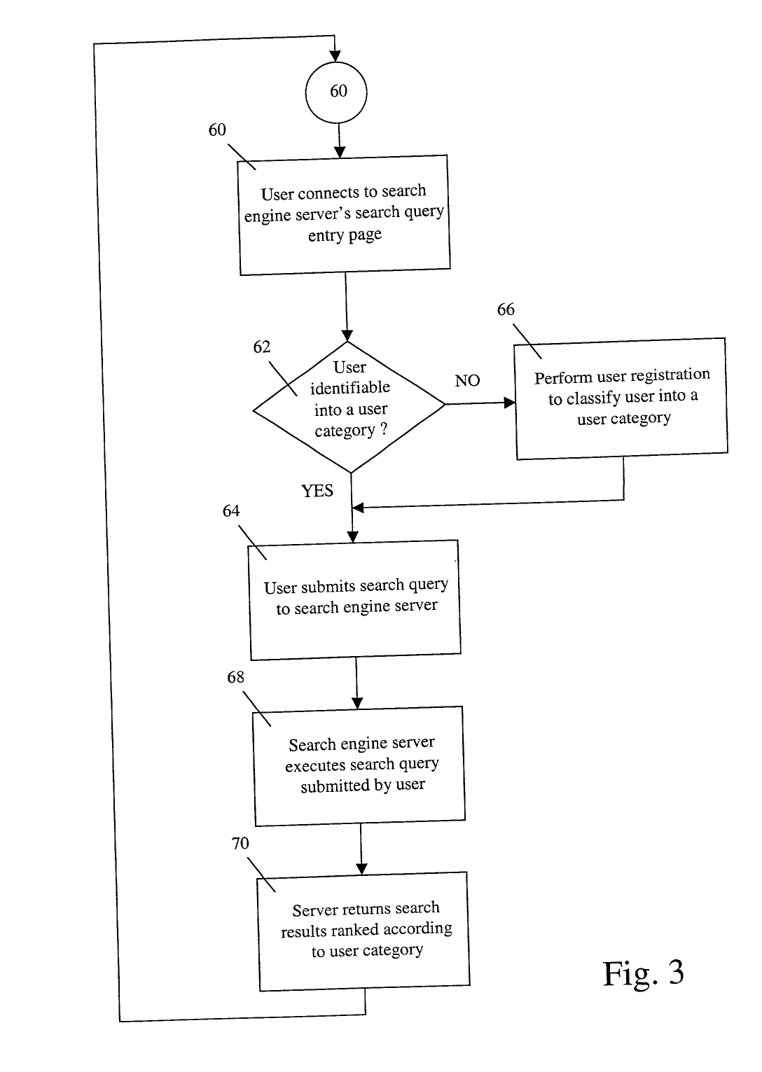

Turning now to FIG. 3, a flow diagram illustrating an embodiment of a method for ordering search results of files available over a network is shown. The method of FIG. 3 may be performed using a system such as system 10 of FIG. 2. Generally speaking, the method may be applicable to a plurality of users using a plurality of network clients linked to a search engine server such as server 12. For simplification purposes, the method describes an embodiment for a user of a network client connected to the search engine server.

The method of FIG. 3 begins with by a user of a network client (such as client 28 of FIG. 2) connecting to a search engine server (such as server 12 of FIG. 2). The network client connects to the search engine's search query entry page, which may be a web page, for submitting user entry of search terms, or keywords as shown in box 60. The search terms may include words or phrases corresponding to web pages or files, the user may desire to be retrieved. The network client may connect to the search engine server through a web browser, such as browser 40 of FIG. 2. Upon connecting to the search query page, the search engine server may attempt to identify a user with a user category (box 62). As discussed further below, a user category may include users with similar profiles, or characteristics, as determined by various means. A plurality of user categories may be pre-defined to which a user may be initially assigned. If the search engine server cannot identify a category of the user, as shown by the “No” branch of decision box 62, the method may then proceed to initiate user registration (discussed further below) to obtain information from a user to generate a user profile and assign an initial user category for the user (box 66). If the user can be identified with a user category, the method proceeds along the “Yes” branch of decision box 62. Upon identifying the user category or completion of user registration, a user may then submit a search query to the search engine server as shown in box 64. The search query may include one or more search terms and be entered through the browser. The search terms may include words or phrases associated with desired topics. The search terms may also be associated with desired files or websites. Broadly speaking, the search terms may include one or more words and/or phrases, associated with information content accessible over a network. The information content may be found in a plurality of files accessible over a network. Upon receiving the search query from the user, the search engine server may then proceed to execute (as discussed further below) the search query, shown in box 68. The search engine server may then return, or provide, search results to the user as shown in box 70. The search results, as outlined further below, may be ranked in accordance with the user category. The method may then proceed to return to box 60 in which the user may proceed with a different search query.

As mentioned above, user categories may be pre-defined and utilized by the search engine server. The user categories may define categories in which users with similar profiles or characteristics may be assigned, to provide for search results ranked in accordance with the user category. The user categories may include various categories and may be defined by the developers of the search engine server. The user categories may also be defined from information obtained through advertising profile services such as Doubleclick. Such profile services may provide initial user categories to be selected based on user demographics, for example. However, because search engine servers may serve different needs and functions for a given network, the user categories may ultimately be tailored to the needs of the users and/or administrators of the network. Merely as an example, the user categories may include topics such as age, profession, geographical location, sex, or interests and hobbies of a user. Other topics for defining user categories are naturally available and may be utilized. A simple user category scheme may employ one user category. For example, the scheme may employ a category such as the user profession. Alternatively, a plurality of categories may be employed to result in one or more user categories assignable to a user. Employing more than one category may allow for a greater degree of flexibility in returning search results and allowing for additional refinement in tailoring the search results for the user. For example, a user category scheme may include the topics of age, geographical location, and interests for users. For instance, the “age” topic may include categories defined for users under the age of 18, between the ages of 18 to 25, and over the age of 25. As another example, the “geographical location” topic may define categories for users in North America, Europe, Asia, the Middle East, Africa, and South America. The categories may also define users in regions of a country. For example, for users residing in the United States, the categories may include regions such as the West coast, the East Coast, the Northwest, the South, the Southwest, the Central, and the Northeast. In a similar fashion, the “interests” topic may include categories defined for users who have interests in sports, travel, health, movies, books, and business, for example. The examples of specific topics and user categories are merely for illustrative purposes, however. Broadly speaking, user categories may include any category associated with defining profiles of users with similar characteristics. User categories may allow the search engine server to return search results ranked in accordance with one or more user categories. Such methods may allow the user to quickly identify the more relevant search results.

A user may be identified with, or assigned to, a user category through various means. In one method, a user may be asked to “register” with the search engine server upon an initial visit to the search website. Registering may be achieved by requesting the user to fill out a form, provided to the user by the search engine server, including information entry fields to obtain specific information from the user. The information may then be used to determine one or more initial categories for the user. The form may be an HTML-formatted file and be submitted from the search engine server to the user through a network client. Other file formats of the form may be used. The form may be a file stored in a storage device such as storage device 16 of FIG. 2. Upon receiving the form, which may be displayed on the output device of the network client, a user may proceed to provide the requested information and resubmit the form to the search engine server. The server may then extract the information embedded within the form to assign one or more categories to the user. For example, the form may request user information including the age, the residence, the profession, and interests of the user. Other types of information may be requested as well. The form may also request user information in accordance with advertising profile services, if these services are utilized. These pieces of information may then be utilized to define one or more user categories associated with the user so that search results returned to the user may be ranked in accordance with the user category.

In an alternative method of identifying a user with a user category, a user may initially submit their e-mail address to the search engine server through means of a form or embedded into a request, such as an HTTP request, from the network client to the search engine server. The server may then extract an initial user category by comparing the e-mail address to e-mail addresses previously associated with the defined user categories. In particular, a syntax for an e-mail address includes the following; user name@domain name. The “user name” identifies the name of the user. The “domain name” identifies the address of the user. In one embodiment, the address is an internet protocol address. The domain name may include a suffix that indicates which top-level domain it belongs to. For example, a domain name with a “.gov” suffix typically identifies users who are affiliated with government agencies. Similarly, an “.edu” suffix may identify users who are affiliated with educational institutions and a “.mil” suffix may identify user who are affiliated with the military. A suffix of“.ca” may be reserved to identify users who are located in Canada. A “.th” suffix may be for users who are located in Thailand. By utilizing the information embedded in the domain name suffix for an e-mail address, a search engine server may extract an initial category of the user with suffixes that have been assigned to established user categories. As an example, a user who connects to the search engine server and provides an e-mail address with an “.edu” suffix may be assigned into a user category, such as education level, associated with college academia. Another user, who connects to the server with an e-mail address with a “.ca” suffix, may be initially assigned into a user category, such as geographical location, associated with Canada. However, if the suffix of the e-mail address is not recognized to be associated with a user category, the search engine server may then proceed to request the user to fill out a registration form as described above.

A user may also be allowed to directly specify a category to be associated with. Such a method may desirable in situations where an initial category, assigned to the user by one of the identification methods described above, is not indicative of the user's profile or desires. Alternatively, a user may decide in the future to change their associated categories to a new set. The user may specify the category after an initial category has been assigned or the user may specify the category initially upon registration with the search engine server. This may be achieved by fields in a registration form that allows a user to check one or more categories, which he/she may have the desire to be associated with. Alternatively, the user may further specify the desired user category as a part of the search query submitted to the search engine server. The server may then identify the desired category and return search results ranked in accordance with the desired category.

In the methods described herein for identifying a user with a user category, information regarding the category assigned to the user may be stored for later retrieval by search engine server. In an embodiment, the information may be stored in a cookie that resides on the storage device of the network client, such as storage device 32 of FIG. 2. The cookie may be used to identify, to the search engine server, the user of the network client. The cookie may contain information that may be used to associate the user with a user category or the cookie may contain information directly identifying the user category. Upon a visit to the website of the search engine server by a network client, the search engine server may create a cookie in response to a first request from the client and assign a session identifier for the cookie. The cookie for the session identifier may then be passed back to the client along with the request response. On subsequent requests by the same client, the client may send the cookie as part of the request to the search engine server, allowing the search engine server to retrieve or identify client specific information it has kept on previous transactions with the client. The cookie may be created by a program script and stored as a text file. Accordingly, upon future visits to the website, the cookie may be submitted to the search engine server to identify the category of the user. In an alternative embodiment, information associating a user with a user category may be stored onto a server-side storage device such as storage device 12 of FIG. 2. In this instance, the information may be retrieved when a user connects to the website and performs a login process. The login process may include entering a user identification and user password, which uniquely identifies the user to the search engine server. Upon completion of the login process, user-specific information may be retrieved by search engine server. The information may be used to identify the category of the user.

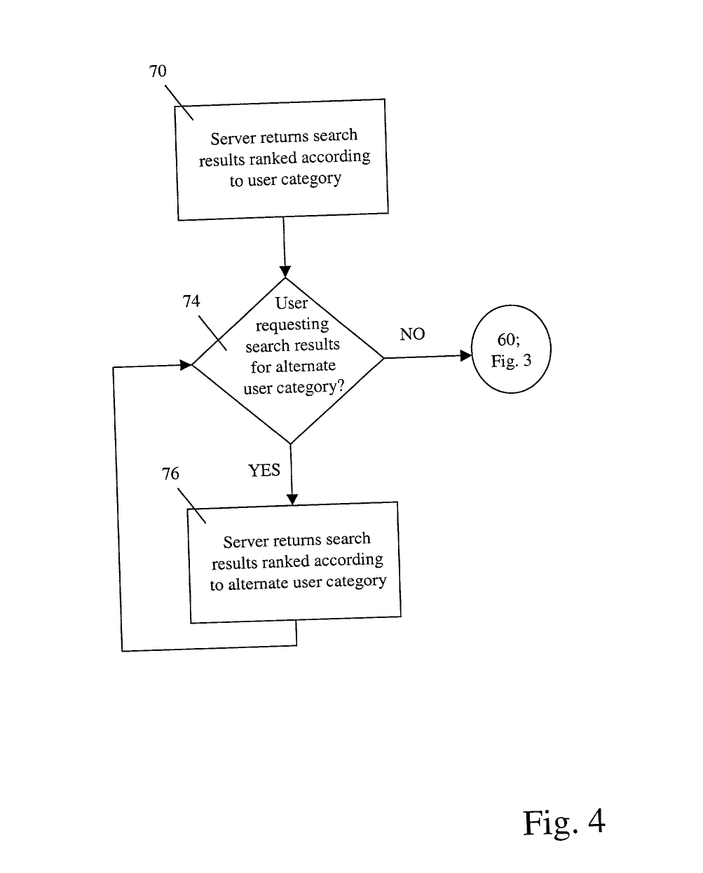

Turning now to FIG. 4, a flow diagram illustrating an alternative embodiment for performing the methods described herein is shown. The method may be an extension of the methods described in FIG. 3. As shown in box 70, the server returns search results ranked in accordance with the user category as identified by the methods of FIG. 3. The method may then continue to determine if the user requests the search results to be ranked in accordance with an alternate user category as shown by decision box 74. This request may be a result of the user desiring to view the search results ranked with user categories not assigned to the user. It may also include a request for search results ranked in accordance with other categories assigned to the user. For example, a user who has initially been assigned to a geographical location category, “Canada”, may wish to see the search results ranked in accordance with a geographical location category, “Thailand” instead. Rather than changing the base user category that the user has been assigned to, the search engine server would simply rank the search results in accordance with the alternate user categories requested. Accordingly, if the user requests search results for an alternate user category, as shown by the “Yes” branch of decision box 74, the server proceeds to return the search results ranked in accordance with the requested category as shown in box 76. If the user does not wish to view the search results ranked in accordance with an alternate category, the method may proceed back to box 60 of FIG. 3, as shown by the “No” decision branch of box 76.

Returning to the method of FIG. 3, search results ranked in accordance with a user category may be returned to a user by the search engine server as shown in box 70. The search results may include a list of files, such as web pages or documents, meeting the search criteria submitted by the user. The list of files is ranked in accordance with the user category. As will be explained further below, the list of files may further be ranked in accordance with a category weight assigned to the file. The ranking may be performed such that the file with the highest category weight is listed first and the file with the lowest category weight is listed last. Alternatively, the ranking may also be performed such that a portion of the files with lower category weights may be omitted altogether. Such a method may be useful for situations in which files deemed inappropriate or non-applicable to specific user categories are “filtered” out. Furthermore, for situations in which two or more files have equal category weights, the files may still be placed between higher weighted files and lower weighted files. Generally speaking, ranking search results by the methods described herein present to the user files that may have more relevance residing higher and the files with less relevance residing lower in the search result list. Accordingly, the user may find the more relevant files quickly and efficiently. In search situations wherein the search criteria returns search results with a particularly large amount of files, ranking the files from the search results in accordance with a user category may allow the desired information to be examined efficiently.

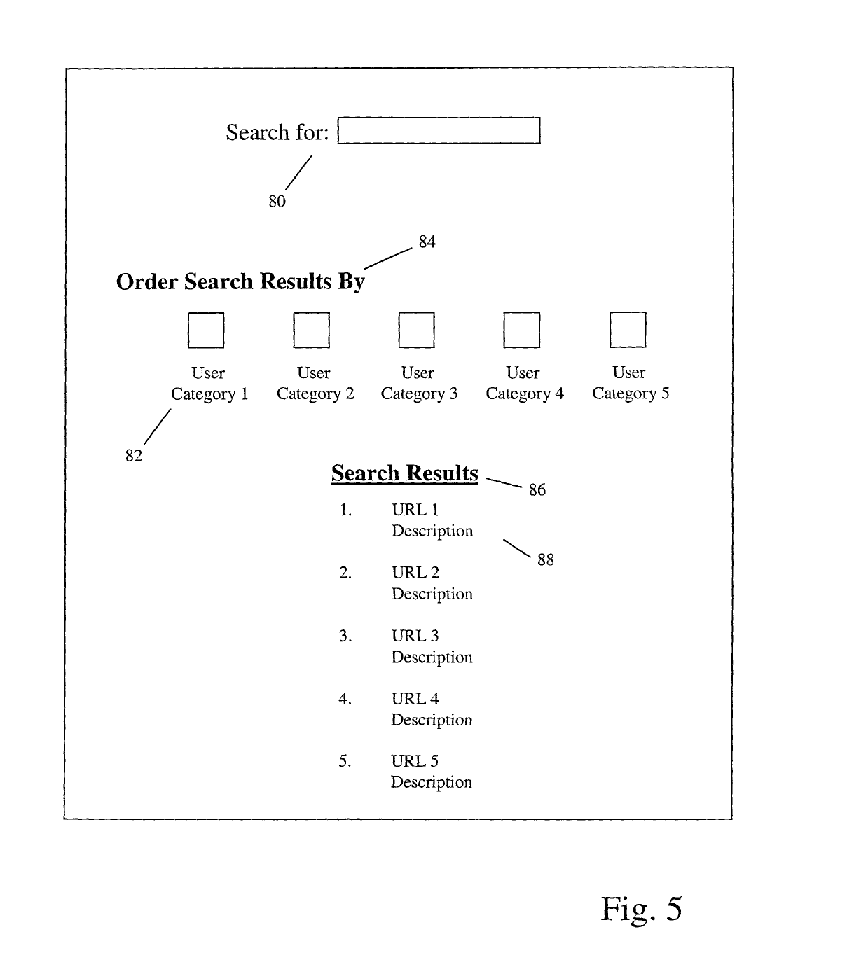

FIG. 5 illustrates an embodiment of a search result list that may be returned to the user from the search engine server. The list may be formatted using HTML or alternative standards such as WML or XML, for example. Names of the elements appearing in FIG. 5, and throughout this disclosure, are illustratively used and are not meant to be limited to or to be construed to such specific nomenclature. Furthermore, the location and placement of the elements found in the search results list may be arranged differently from what is shown in FIG. 5. The search result list may be returned to the user upon ranking search results in accordance with a user category by the search engine server. The search result list may include a “Search for” tag 80 for showing the user what search terms, as entered by the user, were utilized in returning the search results. Tag 80 may further allow the user to modify the search criteria or initiate a new search by entering information into the dialog box of tag 80 as shown. The search result list may further include a “Search Results” tag 86 which may serve to present the search results ranked in accordance with a user category. Beneath tag 86 may appear a list of the files returned from the search results, and ranked in accordance with a user category as described herein. Each file description 88 may include the file address, such as the URL address, the title, and/or a short description of the file. Search terms or terms similar to the search terms, used in locating the file may also be included in the description. Each file description may further be a link, or hyperlink, to the file itself. The search results list may further include an “Order Search Results By” tag 84, which may allow a user to rank the search results in accordance with an alternate category 82 as shown. The number and type of alternate categories shown on the page may vary and be dynamically chosen based on the search terms and user category chosen. Although shown as one page in FIG. 4, search results may return a list of files larger than what may be shown on one page. In such cases, the list may be spread across two or more pages, with the first page starting with the highest ranked file first. The remaining pages may also include tags 84 and 80, or may exclude them to allow more files to be listed on those pages.

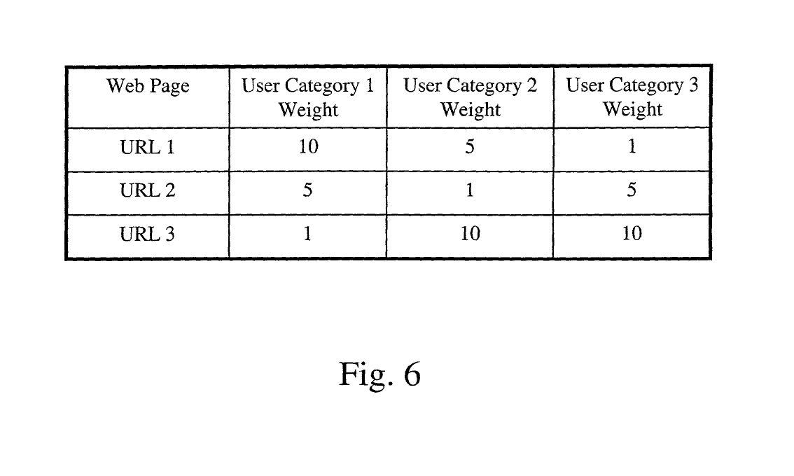

As mentioned above, a user category weight may be associated to a file indexed within a search database. The category weight may be a value assigned that determines the degree of relevance or suitability of the file to the user category. In an embodiment, higher values of the category weight may suggest a higher degree of relevance or suitability. FIG. 6 illustrates an exemplary portion of a database that may be employed to perform the methods described herein. The database may be a database such as search database 24 of FIG. 2. The database may also include other information not shown. For example, the database may include a field for keywords associated with the file& The keywords may be words or phrases, or variations of the words or phrases, which may describe or be contained in the content of the file, the title of the file, or the Meta Tag of the file. The keywords are used to match search terms received by a user. Files whose associated keywords correspond with at least one search term may be identified as satisfying the search criteria and flagged for being returned in a search list to the user. The database may also include other fields for additional weighting factors and other information that may be used in executing a search query for a user. In a presently preferred embodiment, search database 24 may be a relational database. Returning now to FIG. 6, the database may include a field, “Web Page,” that may be populated with entries for files available over the network. Entries for files that have been indexed by the search engine server may reside in the search database. The Web Page field may include the file address, such as the URL address, for each entry. It may also include a short description of the file content. The description may also reside in a separate database field. In this example, three entries are listed: “URL 1,” “URL 2,” and “URL 3.” The database may also include additional fields for user category weights values to be assigned to each file entry. In this example, weights for three user categories are present and include different values for a given URL and a given user category. Naturally, the weights within a user category may be assigned equal values if warranted. Accordingly, in the example of FIG. 6, URL 1 has been assigned category weights of 10, 5, and 1 for user category 1, user category 2 and user category 3 respectively. In similar fashion, user category 1 has weights of 10, 5, and 1 assigned for URL 1, URL 2, and URL 3 respectively. Consequently, for the methods in which the rank of the file is in inverse order to the weighting value and assuming all three URLs correspond to a search criteria, a user assigned to user category 1 would receive a search result list ranked with URL 1, URL 2, and URL 3 in that order. Similarly, a user assigned to user category 3 would receive a list ranked with URL 3, URL 2, and URL 1 in that order. Alternatively, if the ranking of the files is directly proportional to the category weight value, a user assigned with user category 2 would receive a list ranked with URL 2, URL 1, and URL 3 in that order.

Given a plurality of user category groups, the category weight values may be assigned or determined through various means. A search engine server may employ one or more of the means described herein. In one embodiment, the category weight may be assigned manually by a human analyzing the relevance of the file for the defined user categories. Based on this analysis, a category weight value may be assigned to each file examined. However, for a network in which a large quantity of files may be available, associating category weights by human analysis may not be efficient and practical. Accordingly, automated methods discussed below may be used instead of or in addition to the manual method. A portion of the automated methods may be achieved through use of a “spider” or “web-crawler” as described herein. The spider or web-crawler may be adapted to perform the methods for associating appropriate values for the user category weights as discussed. One such method may employ the use of the Meta tag identifier, which may be embedded in the file. The Meta tag is a standard placeholder in the file where keywords for the file are typically inserted by the author of the web page. The author may further insert data into a Meta tag assigned for associating a category weight to the file. For example, a search engine server may communicate to authors of web pages that inserting the phrase “college level” into the Meta tag would associate the appropriate category weights to user categories such as education level. Thus, upon indexing of the web page in the search engine server, the server may examine the Meta tag for phrases or words that may establish the appropriate category weights to each applicable user category.

Another method for identifying appropriate user category weights may be done by examining the domain name for the file address. The domain name identifies to the search engine server the top-level address of the file. For example, in an URL for file including the address, “www.website.com/files/file.html,” the domain name is website.com and the file resides in the website.com domain in the “files” directory. By examining the domain name of the file, the search engine server may further associate an appropriate category weight. For example, for a file having as part of the URL, “www.nytimes.com,” the search engine server may recognize the domain name and accordingly assign a category weight to “New York” versus “Los Angeles” for the topic of geographical location. Conversely, a file having as part of the URL, “www.latimes.com,” may be assigned a higher category weight to “Los Angeles” than “New York” by the search engine server. Similarly, the server may also examine the full URL address of the file to determine appropriate user category weights. For example, the administrator of a website may inform the owner of the search engine server that files located in the address, “www.books.com/sports,” all pertain to sports. Accordingly, the search engine server may then index all files in the “sports” directory of that website with appropriate category weights for sports-related topics. Extending the concept further, if the address further included “www.books.com/sports/women,” the server may then recognize that all files under the /sports/women directory of the website may pertain to women's sports and assign appropriate category weights.

Identifying appropriate category weights may also be done by generating a form that an author of a file may submit to the search engine server. The form may be in addition to the file to be indexed in the search database. The form may include information pertaining to the file content and the desired audience. Based on this information, the search engine server may then assign the appropriate category weights to the file. In yet another method, the server may examine the grammar level of the file content in determining appropriate category weights. For example, if the grammatical analysis of the file results in the file receiving a value associated with a level for college students, the file may be associated with category weights for topics of education level, with perhaps the “college student” category receiving the highest category weight value. The server may also examine the file content for special terms or phrases that have been determined to be more applicable to certain user categories. For example, for files that include terms such as “engineering,” “capacitors,” “resistors,” and “inductors,” the server may then assign appropriate category weights to the topic of profession, with perhaps the “electrical engineer” category receiving the highest category weight value. The method may also utilize the services of an advertising profile server, such as Doubleclick, for example. Such services may analyze where users with similar characteristics tend to link to/from on the network and make that information available to search engine servers. For example, the profiling service may determine that users, with a profession such as a doctor, frequently connect to websites such as “www.health.net” and “www.cancer.org” (fictitious website names). With this information, the search engine server may then assign the appropriate category weight to the user categories with a profession such as a doctor or a nurse.

Values of the category weights may also be tailored for individual users or groups of users as well. In particular, the search engine server may be adapted to monitor the online habits of a user and determine which files or websites the user frequently selects from a search results list. The server may then compile a history of these files or websites and factor them into the ranking of future search results for the user. In the case of groups of users, the server may further monitor which files or websites the users of a certain category or categories frequently select from their search result lists, The server may then compile a history of these files and websites and adjust the category weight values higher to reflect their popularity with the groups of users.

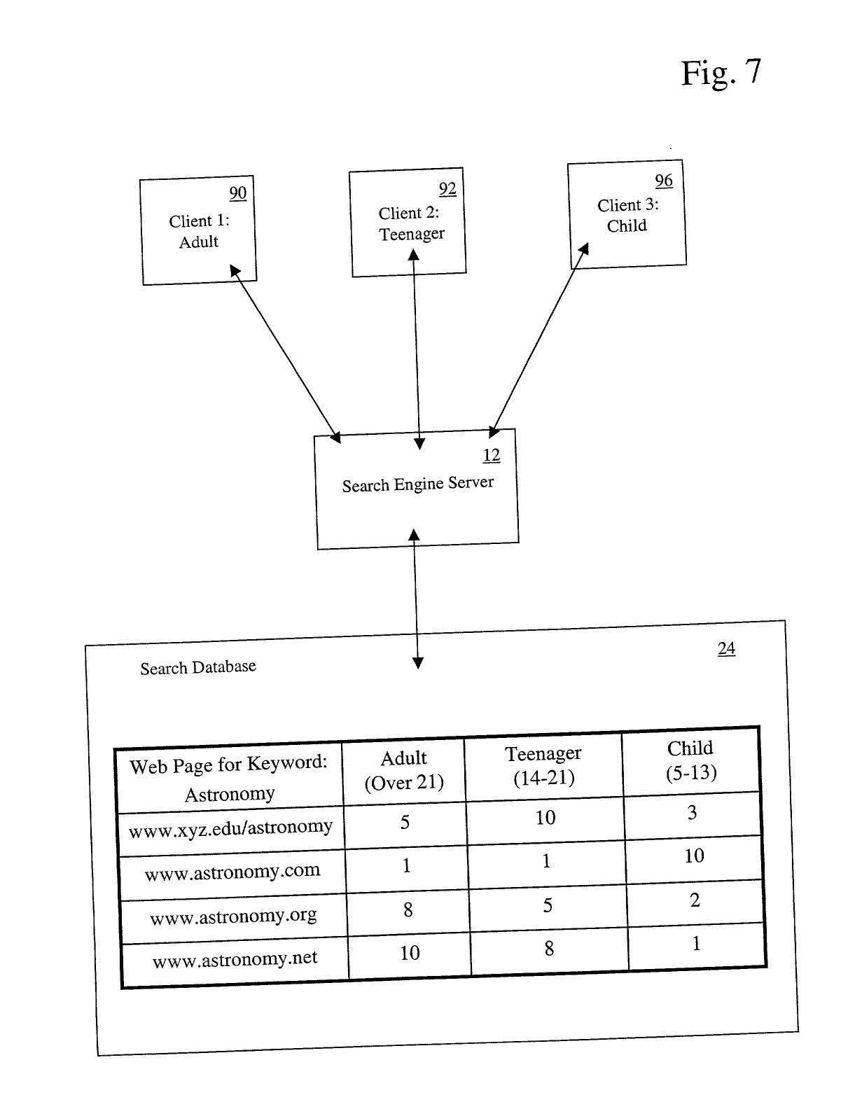

As a simple example to help illustrate the concept of ranking search results in accordance with a user category, consider FIG. 7. Names used in this example are fictitious. Three clients, 90, 92, and 93 are connected to a search engine server, such as search engine server 12 of FIG. 2. The user of client 90 has been associated with a user category for an age level: “Adult.” Similarly, the user of client 92 has been associated with “Teenager” and the user of client 96 has been associated with “Child.” The users are associated through one or more methods for identifying a user category as described herein. Search engine server 12 may include a search database such as search database 24 of FIG. 2. Residing on search database 24 could then be a portion of the database including a “Web Page” field, and category weight fields Adult, Teenager, and Child. The web page field lists entries for web pages associated with the keyword “Astronomy.” The category weight fields include weight values assigned for each web page for a given user category. Through one or more methods such as those described herein for associating a category weight to a file, search engine server 12 has associated the following category weights to the web pages as shown. In this example, higher category weight values indicate higher levels of relevancy to the user category. The web page with the URL address “www.xyz.edu/astronomy” may contain information concerning the astronomy department of a university. The web page with the URL address “www.astronomy.com” may contain basic information about astronomy. The web page with the URL address “www.astronomy.net” may contain scientific information about astronomy. The web page with the URL address, “www.astronomy.org” may contain information about a professional organization for workers in the field of astronomy. Accordingly, the search engine server may have determined“www.xyz.edu/astronomy” the most relevant to the user category for a teenager. Similarly, “www.astronomy.com” may be determined most relevant to a Child and “www.astronomy.net” may be determined most relevant to an Adult.

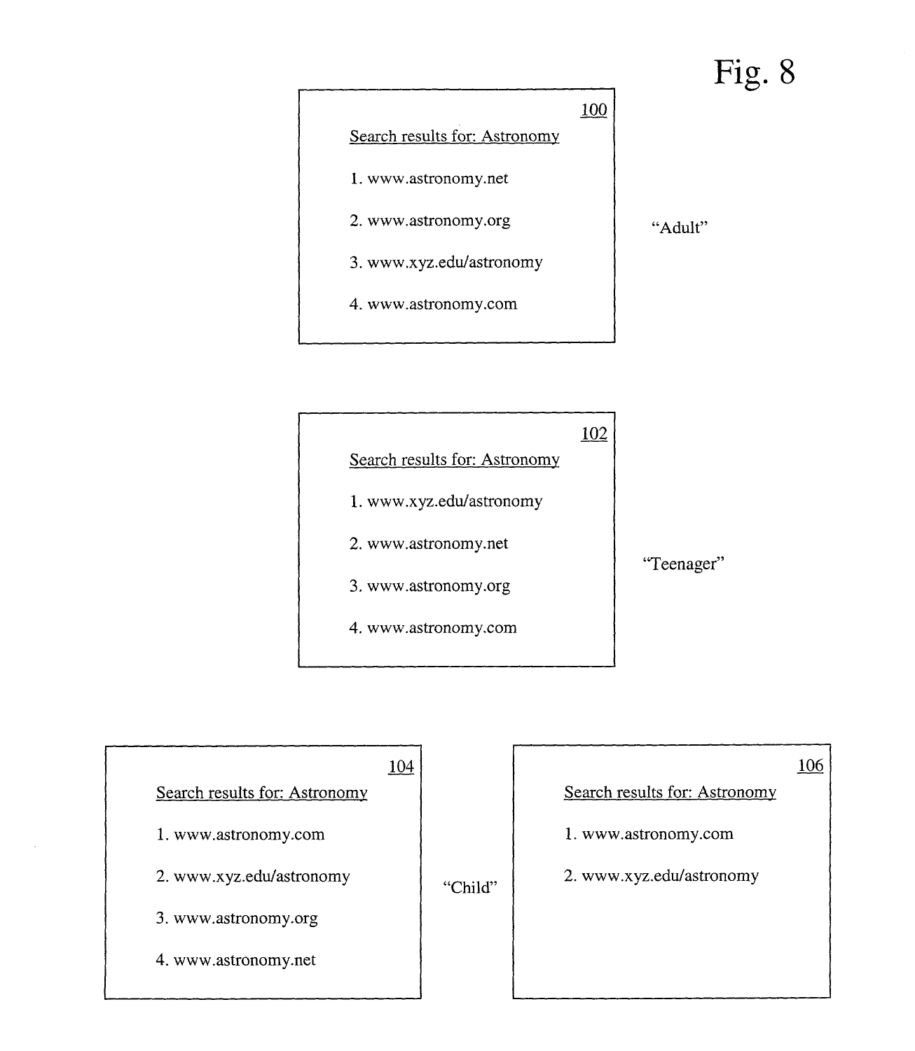

Client 90 may connect to search engine server 12 and submit a search query, for the user, including the search term, “astronomy.” Accordingly, search engine server 12 may then examine search database 24 for all entries associated with the keyword, astronomy. Search engine server may then compile the list of the corresponding entries and generate a search result list. Because the user of client 90 has been identified to be an Adult, the server provides search results ranked in accordance with the Adult category. As shown in FIG. 8, search results 100 may be returned to Client 90. In particular, search results 100 have ranked “www.astronomy.net” first, “www.astronomy.org” second, “www.xyz.edu/astronomy” third, and “www.astronomy.com” last in accordance with the category weights assigned to the user category for an adult. Search results 102 and 104 are also ranked in accordance with category weights assigned to the user categories for a teenager and a child respectively. Thus, the ranking of the search results in accordance with a user category has provided results tailored to the user category for all three clients. In some methods for ranking search results, as previously discussed, a portion of files with lower category weights may be determined to be of limited relevance or suitability to a user category. As a result, a threshold weight value may be assigned in which files with category weight values lower than the threshold value may be omitted, or filtered out, for that specific user category. As an example, consider search results 106 in FIG. 4. The search engine server may have assigned a threshold weight value of“3” as a cutoff for ranking. Thus, a user assigned to the category of a Child may be returned search results listing the first two files only.

The concept of returning search results ranked in accordance with a user category may be further extended to alternative embodiments of the methods described herein. Although the example discussed in FIGS. 7-8 illustrates the association of a user with one category, the method may readily be applied to associating a plurality of user categories with a user. For example, a search engine server may have defined a plurality of user categories for topics such as age level, profession and geographical location. Search results can then be returned in accordance with various combinations of the user categories associated with the user. For instance, the search results may be ranked in accordance with the combined category weights for all three subjects to the user. In another instance, the search results may be ranked in accordance with two out of the three. Alternatively, the search engine sever may allow the user to select the number of associated categories to use in returning the search results. Because the category weights may reside in a database such as search database 24 of FIG. 2, the plurality of category weights are readily available to combine and rank search results according to the needs of the server and the user. Broadly speaking, the methods may be extended to any number of user categories that may be used in any combination to provide search results ranked in accordance with the user categories selected.

Furthermore, the ranking of search results in accordance with one or more user categories may augment one or more other schemes for ranking search results. For example, search results may be first ranked according to alternative ranking criteria. In one embodiment, the search results may be ranked using popularity weighting. As discussed above, a popularity ranking scheme may return search results based on the frequency of the web pages selected by users on their presented search results. The amount of time spent on the specific web pages may also be monitored and factored into the final ranking. Alternatively, the search results may be ranked using an importance weighting as described herein. Other weighting schemes may be employed as well. Regardless of the particular weighting scheme, the search results may be augmented by the ranking criteria according to a user category, which may then generate a final set of search results to the user. The final search results may be ranked in accordance with a combination of the additional weighting scheme and the user category weight scheme. For example, the additional weight value and the user category weight value may be summed to generate a combined weight value associated with a file. The weight values may also be averaged.

In the methods described herein, execution of the various embodiments may be performed by a server such as search engine server 12 that may be a part of a system such as system 10 of FIG. 2. Search engine server may include search instructions, residing in search program 22, for example, executable to perform the methods discussed above. Alternatively, additional hardware or firmware may be utilized to perform the functions described. The search instructions could reside in another software module, such as program instructions 20. The search instructions may be stored on a computer-compatible carrier medium such as the storage medium or the transmission medium described herein. Merely as an example, the search instructions may include software code executable to identify a user with a user category and to associate a category weight to files indexed in a search database. The search instructions may further be executable for returning search results in accordance with the ranking methods described herein. Data regarding the category weights, user categories, information for associating user category weights to files and information for associating a user to a category may be stored in search database 24 or may be stored in another storage area not shown. Broadly speaking, search engine server may contain any instructions and data for performing the various embodiments and variations of the embodiments of the methods described herein.

It will be appreciated by those skilled in the art having the benefit of this disclosure that this invention is believed to provide a system and method for ranking search results of files available over a network. Furthermore, it is also to be understood that the form of the invention shown and described is to be taken as exemplary, presently preferred embodiments. Various modifications and changes may be made without departing from the spirit and scope of the invention as set forth in the claims. For example, the system and methods described herein may be implemented using many combinations of hardware and/or software, and at one or more of many different levels of hardware and/or software, as is the case with many computer-related applications. It is intended that the following claims be interpreted to embrace all such modifications and changes.

What is claimed is:

1. A method for identifying files available over a network, the method comprising:
receiving a search query from a user, wherein the user is associated with a user category; and
providing search results to the user, wherein the search results are ranked in accordance with the user category.

2. The method of claim 1, further comprising providing additional search results to the user, wherein the additional search results comprise the search results alternately ranked in accordance with an alternate user category dissimilar to said user category.

3. The method of claim 1, further comprising identifying the user category.

4. The method of claim 1, wherein said receiving comprises receiving one or more search keywords.

5. The method of claim 4, wherein said providing comprises:
searching the entirety of a database, wherein the database comprises entries indexed with files available over the network.
generating a search result list, wherein the list comprises one or more files, each corresponding to at least one search keyword; and
returning the search result list, ranked in accordance with the user category, to the user.

6. The method of claim 5, further comprising associating a category weight with each indexed file.

7. The method of claim 1, wherein the network comprises the Internet.

8. The method of claim 6, wherein said returning comprises returning the search result list such that the list is ranked starting with the file having the highest category weight value and ending with the file having the lowest category weight value.

9. The method of claim 3, wherein said receiving, said providing, and said identifying is performed by a search engine server

10. The method of claim 9, wherein said identifying comprises registering the user with the search engine server and assigning at least one of a plurality of user categories to the user based on said registering.

11. The method of claim 10, wherein said registering comprises receiving information from the user to determine the category of the user.

12. The method of claim 10, wherein said identifying further comprises extracting one of the plurality of user categories from an e-mail address of the user and assigning the user category to the user based on said extracting.

13. The method of claim 4, wherein said receiving further comprises receiving a request from the user, wherein the request comprises a desired user category.

14. The method of claim 10, wherein the plurality of user categories are based on topics selected from the group including age level, profession, geographical location, hobbies, and interests.

15. The method of claim 6, wherein said associating a category weight comprises associating the category weight based on the file address.

16. The method of claim 6, wherein said associating a category weight comprises associating the category weight based on a user category tag of the file.

17. The method of claim 6, wherein said associating a category weight comprises associating the category weight based on the content of the file.

18. The method of claim 6, further comprising associating an additional weight with each indexed file, wherein said additional weight is associated with additional ranking criteria independent of the user category.

19. The method of claim 18, wherein said returning comprises returning the search result list such that the list is ranked starting with the file having the highest combined category and additional weight values and ending with the file having the lowest combined category and additional weight values.

20. The method of claim 1, wherein said providing search results comprises augmenting initial search results with said search results, wherein said initial search results comprise the search results using additional ranking criteria independent of the user category.

21. The method of claim 1, wherein said providing search results comprises augmenting subsequent search results with said search results, wherein said subsequent search results comprise the search results ranked using additional ranking criteria independent of the user category.

22. A system for identifying files available over a network, the system comprising a search engine server adapted to receive a search query from a user associated with a user category and provide search results to the user, wherein the search results are ranked in accordance with the user category.

23. The system of claim 22, wherein the search engine server is further adapted to identify the category of the user.

24. The system of claim 22, wherein the search engine server is further adapted to provide additional search results to the user, wherein the additional search results comprises the search results alternately ranked in accordance with an alternate user category dissimilar to said user category.

25. The system of claim 22, wherein the search engine server is further adapted to associate a category weight with each file indexed in a search database.

26. The system of claim 25, wherein the search engine server is further adapted to provide search results such that a search result list is ranked starting with the file having the highest category weight value and ending with the file having the lowest category weight value.

27. The system of claim 25, wherein the search engine server is further adapted to associate an additional weight with each indexed file, wherein the additional weight is associated with additional ranking criteria independent of the user category.

28. The system of claim 27, wherein the search engine server is further adapted to provide search results such that a search result list is ranked starting with the file having the highest combined category and additional weight values and ending with the file having the lowest combined category and additional weight values.

29. A system for identifying files available over a network, the system comprising a search engine server, wherein the search engine server comprises search instructions stored on one or more storage devices for receiving a search query from a user and for providing search results to the user, wherein the search results are ranked in accordance with a category of the user.

30. The system of claim 29, wherein the search engine server is adapted to interface with one or more network clients, wherein the network clients provide means for one or more users to connect to the search engine server.

31. The system of claim 29, wherein the search engine server further comprises identification instructions for identifying a category of the user, wherein the identification instructions are stored in the storage device.

32. The system of claim 29, wherein the search engine server further comprises instructions for associating a category weight with each file indexed in a search database, wherein the instructions are stored in the storage device.

33. The system of claim 32, wherein the search engine server further comprises instructions for associating an additional weight with each file indexed, wherein the additional weight is associated with additional ranking criteria independent of said user category.

34. The system of claim 32, wherein the search database is stored in the storage device and wherein the database further comprises data associated with the user category weight and the additional weight.

35. The system of claim 31, wherein the system further comprises data associated with identifying the user category.

36. A computer-usable carrier medium comprising:
first program instructions executable on a computational device for receiving a search query from a user, wherein the user is associated with a user category; and
second program instruction executable on a computational device for providing search results to the user, wherein the search results are ranked in accordance with the user category.

37. The carrier medium of claim 36, further comprising third program instructions executable on a computational device for identifying the category of the user.

38. The carrier medium of claim 36, wherein the second program instructions are further executable to search an entirety of a database, wherein the database comprises entries indexed with files available over a network.

39. The carrier medium of claim 38, further comprising fourth program instructions executable on a computational device for associating a category weight for each file indexed in the database.

40. The carrier medium of claim 38, wherein the second program instructions are further executable to provide search results comprising a list of the indexed files corresponding to the search query.

41. The carrier medium of claim 39, wherein the second program instructions are further executable to rank the list starting with the file having the highest category weight value and ending with the file having the lowest category weight value.

42. The carrier medium of claim 37, wherein the third program instructions are further executable to identify the category of the user by extracting one of the plurality of user categories from an e-mail address of the user and assigning the user category to the user based on said extracting.

43. The carrier medium of claim 37, wherein the third program instructions are further executable to identify the category of the user by registering the user and assigning one of the plurality of user categories to the user based on said registering.

44. The carrier medium of claim 36, wherein the second program instructions are further executable to provide search results ranked in accordance with an alternate user category dissimilar to said user category.

45. A computer-usable carrier medium, comprising:
first program instructions executable on a computational device for associating a user category weight to each file indexed in a search database; and
second program instructions executable on a computational device for generating a search result list, wherein the search results are ranked starting with the file having the highest category weight value and ending with the file having the lowest category weight value.

46. The carrier medium of claim 45, wherein the first program instructions are further executable for associating an additional weight to each indexed file, wherein the additional weight comprises ranking criteria independent of the user category weight.

47. The carrier medium of claim 45, wherein the first program instructions are further executable for associating the category weight by extracting the category weight from the file address.

48. The carrier medium of claim 45, wherein the first program instructions are further executable for associating the category weight by extracting the category weight from the content of the file.

49. The carrier medium of claim 45, wherein the first program instructions are further executable for associating the category weight by extracting the category weight from a user category tag of the file.

50. The carrier medium of claim 46, wherein the second program instructions are further executable for generating the search result list, wherein the search results are ranked starting with file having the highest combined category and additional weight values and ending with the file having the lowest combined category and additional weight values.
